(19) United States
(12) Patent Application Publication
(10) Pub. No.: US 2016/0275914 A1
(43) Pub. Date: Sep. 22, 2016

(54) DISPLAY CONTROL DEVICE AND DISPLAY CONTROL SYSTEM

(71) Applicant: Panasonic Intellectual Property Management Co., Ltd., Osaka (JP)

(72) Inventors: Hiroki SHINOHARA, Kanagawa (JP); Tetsuya SATO, Osaka (JP); Koichiro YAMAGUCHI, Osaka (JP)

(21) Appl. No.: 15/072,627

(22) Filed: Mar. 17, 2016

(30) Foreign Application Priority Data
Mar. 19, 2015 (JP) 2015-056726
Jan. 29, 2016 (JP) 2016-015008

(51) Int. Cl. G09G 5/12; H04W 4/02; H04W 40/24

(52) U.S. Cl. CPC G09G 5/12; H04W 40/244; H04W 4/02; G09G 2380/06; G09G 2370/02

(57) ABSTRACT

A display control device to be connected to a display device and a plurality of mobile terminals includes: a receiver that receives a plurality of pieces of distance information including information for identifying the mobile terminals and information indicating a distance between the display device and each of the mobile terminals; an identification unit that identifies, from the mobile terminals, a specific mobile terminal having a shortest distance to the display device, based on the pieces of distance information; an acquisition unit that acquires attribute information on the specific mobile terminal; an extraction unit that extracts matched attribute information from attribute information on other mobile terminals identified based on the pieces of distance information, the matched attribute information matching the attribute information acquired by the acquisition unit; and a transmitter that transmits information to the display device, based on the matched attribute information.

### BACKGROUND

1. Technical Field

The present disclosure relates to a display control device and a display control system that update display used for digital signage and the like.

2. Description of the Related Art

Some conventional digital signage devices recognize a plurality of users and provide information to the users through digital signage, based on attributes common to the plurality of users.

### CITATION LIST

### Patent Literature

PTL1: Unexamined Japanese Patent Publication No. 2011-002784

### SUMMARY

The present disclosure relates to a display control device and a display control system that are capable of efficiently providing information for specific users.

According to an aspect of the present disclosure, a display control device is to be connected to a display device and a plurality of mobile terminals. The display control device includes a receiver that receives a plurality of pieces of distance information including information for identifying the plurality of mobile terminals and information indicating a distance between the display device and each of the plurality of mobile terminals. The display control device further includes an identification unit that identifies, from the mobile terminals, a specific mobile terminal having a shortest distance to the display device, based on the plurality of pieces of distance information. The display control device further includes: an acquisition unit that acquires attribute information on the specific mobile terminal; and an extraction unit that extracts matched attribute information attribute information on other mobile terminals identified based on the plurality of pieces of distance information; the matched attribute information matches the attribute information acquired by the acquisition unit. The display control device further includes a transmitter that transmits information to the display device, based on the matched attribute information.

The present disclosure relates to a display control device and a display control system that are capable of efficiently providing information for specific users.

### BRIEF DESCRIPTION OF DRAWINGS

FIG. 1 illustrates a configuration of a display control system in an exemplary embodiment;

FIG. 2 is a functional block diagram of the display control device in the display control system in the exemplary embodiment;

FIG. 3 illustrates a concept of a terminal action log in the display control system in the exemplary embodiment;

FIG. 4 is a flowchart of an operation of the display control device in the display control system in the exemplary embodiment; and

FIG. 5 illustrates an attribute information table in the display control system in the exemplary embodiment.

### DETAILED DESCRIPTION

An exemplary embodiment will be described in detailed below with reference to the drawings as appropriate. It should be noted that in some cases, needlessly detailed descriptions will not be given. For example, technical matters known in the art will not be described in detail, or configurations that are substantially the same as those stated previously will not be described. This is for the purpose of preventing description from being redundant and helping understanding of those skilled in the art.

Descriptions that will be given below and the accompanying drawings should be used to help those skilled in the art to fully understand the present disclosure and, are not intended to limit the subject matters in the claims.

An exemplary embodiment of the present disclosure will be described below with reference to the drawings.

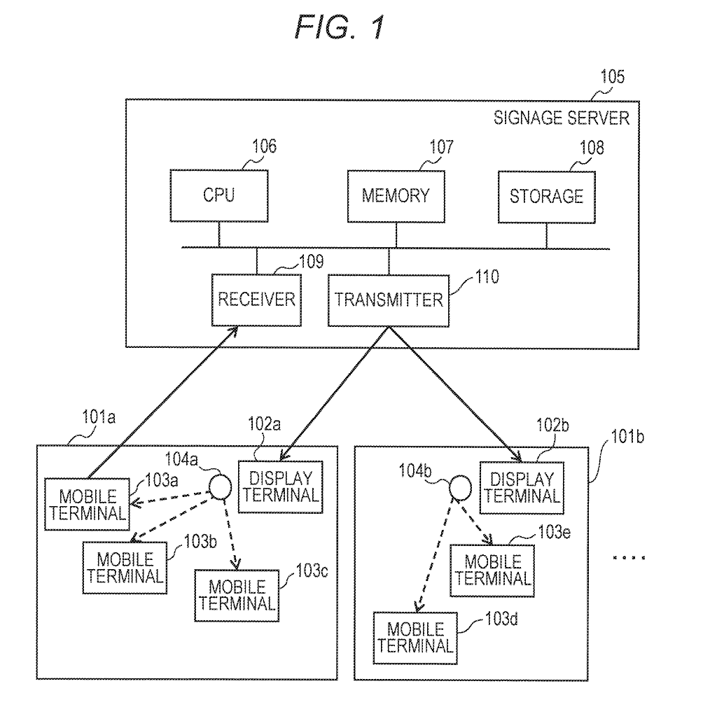

A description will be given of a display control system having a display control device in this exemplary embodiment, with reference to FIG. 1. FIG. 1 illustrates a configuration of the display control system in the exemplary embodiment.

The display control system includes display terminals 102a, 102b, mobile terminals 103a to 103e, beacons 104a, 104b, and signage server 105. Display terminals 102a, 102b are installed at a plurality of sites 101a, 101b, respectively, such as a shop and a station. Mobile terminals 103a to 103e are possessed by users at these sites. Beacon 104a is disposed near the display terminal (digital signage) 102a; beacon 104b is disposed near the display terminal 102b. Beacons 104a issue signals for measuring respective distances between display terminal 102a and mobile terminals 103a, 103b, and 103c. Beacons 104b issue signals for measuring respective distances between display terminal 102b and. mobile terminals 1.03d. and 103e. Signage server 105 is a display control device that distributes, via a network, content suitable for site 101a to display terminal 102a and content suitable for site 101b to display terminal 102b.

Beacons 104a, 104b continuously issue signals containing their identifications (beacon IDs) to be used for beacon identification. Mobile terminals 103a to 103c are each equipped in advance with an application that receives a signal from beacon 104a and measures intensity (radio field intensity) of the signal. Likewise, mobile terminals 103d and 103e are each equipped in advance with an application that receives a signal from beacon 104b and measures radio field intensity of the signal. Each application reports a beacon ID, radio field intensity, a mobile terminal ID for identifying mobile terminals 103a to 103e contained in the received signal to signage server 105 via the network.

While receiving signals from beacons 104a, mobile terminals 103a to 103c report information contained in these signals to signage server 105 at regular time intervals. Likewise, while receiving signals from. beacons 104b, mobile terminals 103d and 103e report information contained in these signals to signage server 105 at regular time intervals. It should be rioted that all mobile terminals 103a to 103e are permitted to communicate with signage server 105 via the network, although only communication between mobile terminal 103a and signage server 105 is illustrated in FIG. 1.

Beacons 104a is installed in order to measure respective distances between display terminal 102a and mobile terminals 103a, 103b, and 103c. Likewise, beacons 104b is installed in order to measure respective distances between display terminal 102b and mobile terminal 103d and 103e. Instead of beacons 104a, 104b, for example, a global positioning system (GPS) may be used to measure relative distances between display terminals and corresponding mobile terminals.

Each pair of display terminal and beacon may be integrally formed.

Mobile terminals 103a to 103c do not have to directly transmit information regarding a distance to display terminal 102a to signage server 105. Alternatively, mobile terminals 103a to 103c may transmit the information via display terminal 102a or another terminal. Likewise, mobile terminals 103d and 103e do not have to directly transmit information regarding a distance to display terminal 102b to signage server 105. Alternatively, mobile terminals 103d and 103e may transmit the information via display terminal 102b or another terminal.

Signage server 105 includes central processing unit (CPU) 106, memory 107, storage 108, receiver 109, and transmitter 110. Receiver 109 receives information regarding beacon IDs, radio field intensity, and mobile terminal IDs that mobile terminals 103a to 103e transmit at regular time intervals. Transmitter 110 transmits contents to be displayed to display terminals 102a, 102b.

Since display terminals 102a, 102b have the same configuration, an arbitrary one of display terminals 102a, 102b will be referred to below as a display terminal. Since mobile terminals 103a to 103e have the same configuration, an arbitrary one of mobile terminals 103a to 103e will be referred to below as a mobile terminal. Since beacons 104a, 104b have the same configuration, an arbitrary one of beacons 104a, 104b will be referred to below as a beacon.

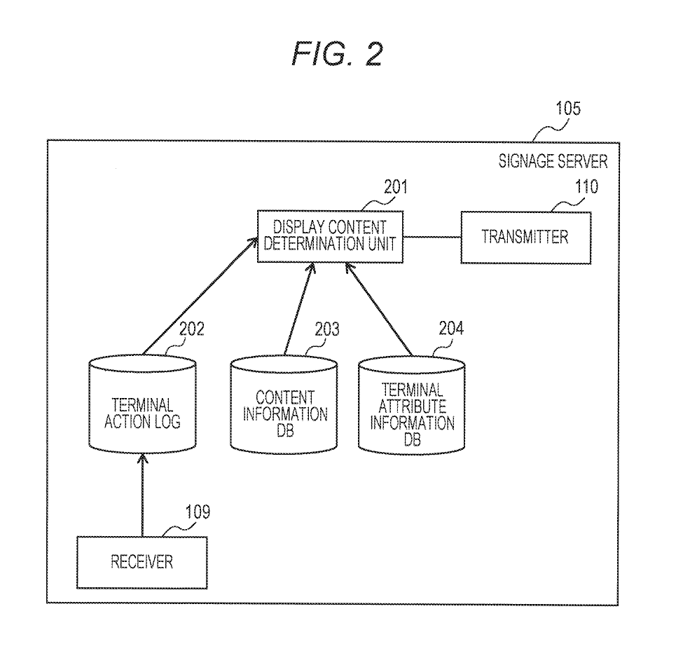

Next, an outline of signage server 105 will be described with reference to FIG. 2. FIG. 2 is a functional block diagram of the display control device in the display control system in the exemplary embodiment.

Signage server 105 includes display content determination unit 201, terminal action log 202, content information database (DB) 203, and terminal attribute information DB 204. Display content determination unit 201 determines which content is to be transmitted to the display terminal. Terminal action log 202 collects information regarding a beacon ID, radio field intensity, a mobile terminal ID, and the like, which is transmitted from the mobile terminal and received by receiver 109. Content information DB 203 retains content to be displayed by the display terminal in association with attribute information. Terminal attribute information DB 204 manages information regarding the user of the mobile terminal, especially attribute information.

Display content determination unit 201 may be implemented by CPU 106 and memory 107. Terminal action log 202, content information DB 203, and terminal attribute information DB 204 are stored in storage 108.

The term “attribute information”, which will be described in detail, refers to user information stored in the mobile terminal. Examples of the attribute information, include, for example, an age, gender, an occupation, and a hobby. Based on this attribute information, display content determination unit 201 determines which content is to be displayed by the display terminal.

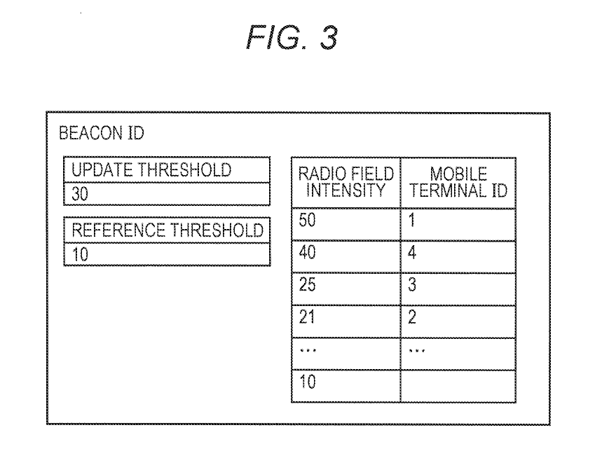

Terminal action log 202 will be described with reference to FIG. 3. FIG. 3 illustrates a concept of terminal action log 202 in the display control system in this exemplary embodiment.

Terminal action log 202 manages beacon IDs, radio field intensity values, and mobile terminal IDs received by receiver 109. Terminal action log 202 manages information for each beacon. Terminal action log 202 contains a plurality of beacon action tables (see FIG. 3).

Each beacon action table includes an update threshold, a reference threshold, and a distance table.

The update threshold is a reference value for determining whether a user is looking closely at the content displayed by the display terminal. In other words, the update threshold is a threshold for determining whether a user is very close to the display terminal. More specifically, the update threshold is a threshold for determining whether the mobile terminal possessed by a user is very close to the beacon near the display terminal.

In this exemplary embodiment, the update threshold may be a value indicating radio field intensity. If a radio field intensity value is greater than the update threshold, a user is very close to the display terminal.

The reference threshold is a reference value for determining whether a user is within a range in which content displayed by the display terminal is viewable. In other words, the reference threshold. is a threshold for determining whether a user is close to the display terminal. More specifically, the reference threshold is a threshold for determining whether the mobile terminal possessed by a user is close to the beacon near the display terminal.

In this exemplary embodiment, the reference threshold may be a value indicating radio field intensity, similar to the update threshold. If a radio field intensity value is greater than the reference threshold, a user is close to the display terminal.

A distance between the display terminal and the mobile terminal, which is specified by the update threshold and the reference threshold, depends on, for example, the size and installation condition of the display terminal. For this reason, update thresholds arid reference thresholds are individually set in respective beacon action tables.

Each of the update threshold and the reference threshold is set to a radio field intensity value proportional to a predetermined distance. For example, the update threshold may be set to a radio field intensity value proportional to a distance of 2 meters; the reference threshold may be set to a radio field intensity value proportional to a distance of 5 meters.

For the above reason, a distance represented by the reference threshold is longer than a distance represented by the update threshold. Therefore, if both the update threshold and the reference threshold are specified by radio field intensity as in this exemplary embodiment, the update threshold is greater than the reference threshold.

The distance table includes a radio field intensity value and a mobile terminal ID. In the example of FIG. 3, the distance table is sorted in accordance with radio field intensity values; however, it is not necessarily necessary to sort the distance table.

The distance table always retains the latest information by updating information every time a radio field intensity value and a mobile terminal ID are received from the mobile terminal. However, the distance table may also store past information together with its reception time. In this case, the reception time may be a time when the mobile terminal transmits information or when signage server 105 receives information.

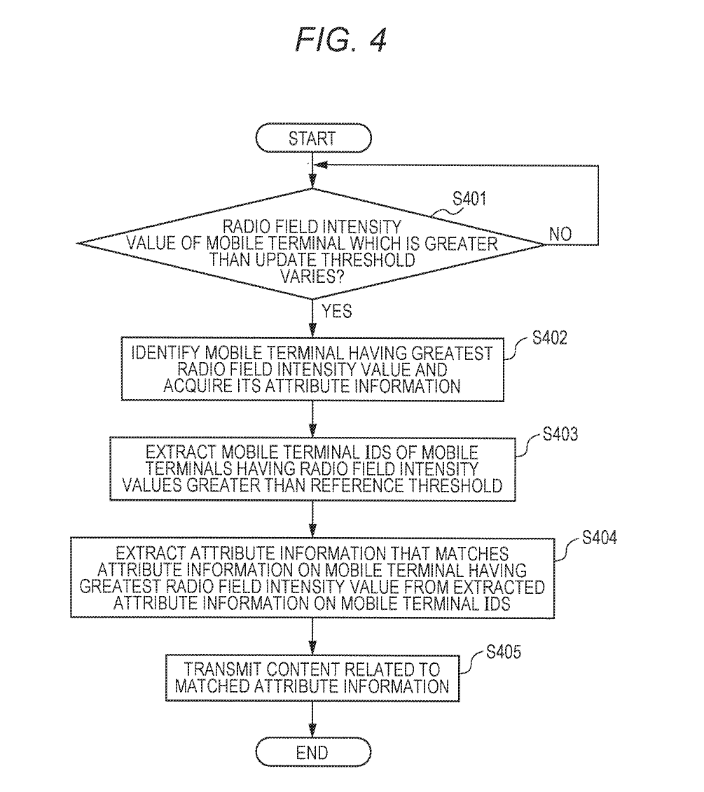

Next, an operation of signage server 105 will be described with reference to FIG. 4. FIG. 4 is a flowchart of an operation of the display control device in the display control system in the exemplary embodiment.

Display content determination unit 201 in signage server 105 determines which contents are to be transmitted to the display terminals. For that purpose, display content determination unit 201 refers to terminal attribute information DB 204 and the beacon action tables for the beacons corresponding to the display terminals, thereby determining the contents. Then, transmitter 110 transmits the determined contents. In short, the display control device performs an operation of the flowchart in FIG. 4 for each beacon ID.

A specific operation of signage server 105 will be described below. In Step S401, display content determination unit 201 refers to a beacon action table and determines whether there are radio field intensity values that are greater than the update threshold and have varied.

The determination may be made at regular time intervals or every time signage server 105 receives an event indicating that the terminal action log 202 has been rewritten.

If there are no radio field intensity values that are greater than the update threshold and have varied (No in Step S401), the process returns to Step S401.

If there are radio field intensity values that are greater than the update threshold and have varied (Yes in Step S401), in Step S402, display content determination unit 201 identifies which mobile terminal has the greatest radio field intensity value in the beacon action table, and then acquires the attribute information on the user related to the mobile terminal ID of the identified mobile terminal.

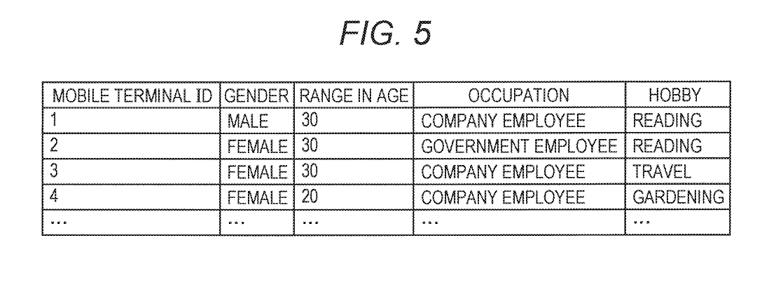

The attribute information will be described with reference to FIG. 5. FIG. 5 illustrates an attribute information table in the display control system in the exemplary embodiment.

As illustrated in FIG. 5, the attribute information table includes a mobile terminal ID and four pieces of attribute information, more specifically gender, a range in age, an occupation, a hobby. The attribute information table is stored in terminal attribute information DB 204 so as to be searchable using the mobile terminal ID as a search key.

In Step S402, display content determination unit 201 identifies a mobile terminal having the greatest radio field intensity value. Then, display content determination unit 201 acquires the attribute information on the identified mobile terminal by using its mobile terminal ID, in Step S402.

In Step S403, display content determination unit 201 identifies mobile terminals whose radio field intensity values are greater than the reference threshold., and then extracts the mobile terminal IDs of the identified mobile terminals. in this case, although the mobile terminal ID that has been identified in Step S402 is also extracted, the mobile terminal ID that has been identified in Step S402 is not extracted (is removed from the extracted mobile terminal IDs) in Step S403.

Display content determination unit 201 acquires the attribute information from the attribute information table in FIG. 5, based. on the mobile terminals ID that have been extracted in Step S403, In Step S404, display content determination unit 201 extracts, from the acquired attribute information, attribute information (matched attribute information) that matches the attribute information extracted in Step S402.

Display content determination unit 201 searches content information DB 203 by using the attribute information extracted in Step S404. As the result of the searching, display content determination unit 201 acquires the content related to the extracted attribute information. In Step S405, transmitter 110 in display content determination unit 201 transmits the acquired content to the display terminals corresponding to the beacon ID.

The operation in Step S401 to Step S405 is performed in beacon action tables illustrated in FIG. 3.

The content transmitted in the above manner is displayed by the display terminal. The display terminal changes its display accordingly.

If no mobile terminal IDs are extracted in Step S403, this means that no other users are near the user, and the attribute information on this user may be used as the matched attribute information.

If a coverage range of a radio wave emitted from the beacon coincides with a range in which the content is viewable, the reference threshold does not necessarily have to be set. In this case, in Step S403, display content determination unit 201 may extract all the mobile terminal IDs registered in the distance table in the beacon action table in FIG. 3, and then may perform the operation in Step S404 and Step S405.

A specific description will be given of a method of extracting the matched attribute information, with reference to FIG. 5. For example, it is assumed that the mobile terminal with the mobile terminal ID No. 1 has the greatest radio field intensity value and the mobile terminals with the mobile terminal ID Nos. 2 to 4 have radio field intensity values greater than the reference threshold.

In the above example, in Step S402 in FIG, 4, the attribute information “male”, “thirties”, “company employee”, and “reading” is extracted. Then, in Step S404, the attribute information regarding the users of the mobile terminals with the mobile terminal ID Nos. 2 to 4, more specifically, the attribute information “female” “thirties”, “government employee”, “company employee”, “reading”, “travel”, and “gardening” is extracted. From this extracted attribute information, the attribute information “thirties”, “company employee”, and “reading”, matching the attribute information extracted in Step S402, is extracted. Display content determination unit 201 picks up contents suitable for the matched attribute information “thirties”, “company employee”, and “reading” from content information DB 203. Then, transmitter 110 transmits the contents to the display terminals.

If the mobile terminal with the mobile terminal ID No. 2 has the greatest radio field intensity value due to a variation in the radio field intensity, the matched attribute information is changed into information “female”, “thirties”, and “reading”. Then, signage server 105 provides content based on this matched attribute information.

In this way, display content determination unit 201 determines which content is to be provided, based on matched. attribute information. In this case, however, display content determination unit 201 may make a determination, based on either a whole of the matched attribute information or a part of the matched attribute information that is related to the majority of users.

As described above, a display control device that corresponds to signage server 105 in this exemplary embodiment is to be connected to a display device that corresponds to display terminals 102a, 102b and a plurality of mobile terminals 103a to 103e. The display control device includes receiver 109 that receives a plurality of pieces of distance information; the plurality of pieces of distance information including: information regarding mobile terminal Ms for identifying the plurality of mobile terminals 103a to 103e; and information regarding radio field intensity that indicates a distance between the display device and each of the plurality of mobile terminals 103a to 103e. The display control device further includes an identification unit that corresponds to display content determination unit 201; display content determination unit 201 identifies, from the mobile terminals, a specific mobile terminal having the shortest distance to the display device, based on the plurality of pieces of distance information, The display control device further includes an acquisition unit and an extraction unit. The acquisition unit that corresponds to display content determination unit 201 acquires attribute information on the specific mobile terminal. The extraction unit that corresponds to display content determination unit 201 extracts matched. attribute information from attribute information on other mobile terminals identified based on the plurality of pieces of distance information: the matched attribute information matches the attribute information acquired by the acquisition unit. The display control device further includes transmitter 110 that transmits information to the display device, based on the matched attribute information.

The display control device configured above provides content based on matched attribute information for users through a display terminal (display device), The display control device can thereby provide content that conforms to preference of the user located closest to the display terminal (display device) and. that also attracts attention of other users around this user.

The display control device may further include terminal action log 202, content information DB 203, and terminal attribute information DB 204. Terminal action log 202 collects the plurality of pieces of distance information. Content information DB 203 retains information to be transmitted to the display device in association with the attribute information the mobile terminals. Terminal attribute information DB 204 manages information regarding users possessing the mobile terminals. This configuration enables the display control device to manage distance information, attribute information on mobile terminals, and users' information independently of one another.

The above terminal action log may contain a plurality of beacon action tables. This configuration enables an update threshold and a reference threshold to be set independently of each other.

When the distance between the specific mobile terminal and the display device changes, the identification unit may re-identify, from the mobile terminals, another mobile terminal having the shortest distance to the display device. In this way, the display control device provides content based on the matched attribute information.

The attribute information acquired by the acquisition unit may be an attribute related to at least one of gender, an age, an occupation, and a hobby. In this way, the display control device determines which content is to be displayed by the display terminal, based on the attribute information.

Information that indicates the distance between the display device and each of the plurality of mobile terminals includes radio field intensities. By using the radio field intensity, it can be indicated how close to each other the users and the display device are positioned.

The display content determination unit may include the identification unit, the acquisition unit, and the extraction unit. This can achieve a simple configuration of the display content determination unit,

A display control system in this exemplary embodiment includes a display control device, a display device, a plurality of mobile terminals, and a beacon. The beacon issues a signal for measuring respective distances between the plurality of mobile terminals and the display device. The display control device configured as above can provide content that conforms to preference of the user located closest to the display device and that also attracts attention of other users around this user.

The display device and the beacon may be integrally formed. This can achieve a simple configuration of the display control system.

According to the present disclosure, a display control device is applicable to, for example, digital signage installed at a shop, a station, and other public spaces.

What is claimed is:

1. A display control device to be connected to a display device and a plurality of mobile terminals, the display control device comprising:
a receiver that receives a plurality of pieces of distance information including information for identifying the plurality of mobile terminals and information indicating a distance between the display device and each of the plurality of mobile terminals;
an identification unit that identifies, from the mobile terminals, a specific mobile terminal having a shortest distance to the display device, based on the plurality of pieces of distance information;
an acquisition unit that acquires attribute information on the specific mobile terminal;
an extraction unit that extracts matched attribute information from attribute information on other mobile terminals identified based. on the plurality of pieces of distance information, the matched attribute information matching the attribute information acquired by the acquisition unit; and
a transmitter that transmits information to the display device, based on the matched attribute information.

2. The display control device according to claim 1, further comprising:
a terminal action log that collects the plurality of pieces of distance information;
a content information database (DB) that retains information to be transmitted to the display device in association with the attribute information on the mobile terminals; and
a terminal attribute information DB that manages information regarding users possessing the mobile terminals.

3. The display control device according to claim 2, wherein the terminal action log contains a plurality of beacon action tables.

4. The display control device according to claim 1, wherein when the distance between the specific mobile terminal and the display device changes, the identification unit re-identifies, from the mobile terminals, another mobile terminal having the shortest distance to the display device.

5. The display control device according to claim 1, wherein the attribute information acquired by the acquisition unit includes an attribute related. to at least one of gender, an age, an occupation, and a hobby.

6. The display control device according to claim 1, wherein the information indicating the distance between the display device and each of the plurality of mobile terminals includes radio field intensities.

7. The display control device according to claim 1, comprising a display content determination, unit including the identification unit, the acquisition unit, and the extraction unit.

8. A display control system comprising:
the display control device according to claim 1;
the display device;
the plurality of mobile terminals; and
a beacon that issues a signal for measuring respective distances between the plurality of mobile terminals and the display device.

9. The display control system according to claim 8, wherein the display device and the beacon are integrally formed.
